(19) United States
(12) Patent Application Publication
(10) Pub. No.: US 2008/0288918 A1
(43) Pub. Date: Nov. 20, 2008

(54) WEB SERVICE TOOL BASED ON BUSINESS OBJECT LAYER

(76) Inventors: Mathias Knura, Speyer (DE); Florian Weigmann, Karlsruhe (DE); Peter Conrad, Leimen (DE); Markus Kupke, Diehlheim (DE); Thilo Berndt, Sinsheim (DE); Silke Arians, Hamburg (DE); Marek Barwicki, Schwetzingen (DE); Martin Simmet, Ottweiler (DE); Manjunath Gubbi, Staten Island, NY (US); Arman Voskanian, Montreal (CA); Uwe Reimitz, Wiesloch (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/748,112

(22) Filed: May 14, 2007

(51) Int. Cl. G06F 9/44

(52) U.S. Cl. 717/106

(57) ABSTRACT

A system for generating a Web service includes a graphical user interface to guide a designer to create a Web service in pre-defined stages. The graphical user interface receives an input that selects an object and associated attributes from a repository of pre-defined business objects. The system includes a Web service generator that automatically generates code describing and implementing the Web service according to the selected object and attributes. The system also includes a Web service engine to perform runtime operations of the Web service.

### FIELD OF THE INVENTION

The present invention relates generally to Web services. More particularly, this invention relates to generating Web services using a Web service tool.

### BACKGROUND

Web services are open interfaces that allow a user of the services to link loosely-coupled systems with a technology that is independent of programming languages and platforms. The World Wide Web Consortium (W3C) defines a Web service as a software system designed to support interoperable machine to machine interaction over a network. In the business context, Web services allow business data to be shared, combined, or modified by heterogeneous computing resources among business partners.

For example, an enterprise may provide a Web service that allows its business partners to enter data (e.g., business leads) into an Adobe® interactive form and upload/email the form to the enterprise's system. This enables the enterprise to collect data offline. The collected data can be modified, combined, and/or synchronized with the system at a later time. As another example, a service provider can use a Web service to send service tickets to service technicians in the field. The service technicians can respond and add field data by filling out a form provided by the Web service.

A Web service is typically implemented as an extensible markup language (XML) object comprised of a combination of contents, application code, functional logic, and application program interfaces (APIs), which can be accessed over any network, e.g., the Internet. The network is typically a TCP/IP based network using the Simple Object Access Protocol or Service Oriented Architecture Protocol (SOAP) standard for message exchanges. A Web service is typically described in a Web Services Description Language (WSDL) file, which is a machine readable description of the operations and message formats supported by the server hosting the Web service. A Web service may be published and discovered, using a Universal Description Discovery and Integration (UDDI) protocol, to enable applications on a remote system to find the Web service.

Conventional Web services are typically designed manually. Function modules and Web service interfaces are conventionally coded by programmers who possess both technical knowledge and business knowledge. Even with highly qualified programmers, the process of creating a Web service may take a long time. As a result, the cost and time for providing a Web service increase greatly.

### SUMMARY OF THE DESCRIPTION

A system for generating a Web service includes a graphical user interface to guide a designer to create a Web service in pre-defined stages. The graphical user interface receives an input that selects an object and associated attributes from a repository of pre-defined business objects. The system includes a Web service generator that automatically generates code describing and implementing the Web service according to the selected object and attributes. The system also includes a Web service engine to perform runtime operations of the Web service. Other features of the present invention will be apparent from the accompanying drawings and from the detailed description which follows.

### BRIEF DESCRIPTION OF THE DRAWINGS

Embodiments are illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

FIG. 1 is a block diagram of an embodiment of a Web service provider and a Web service requester.

FIG. 2 is a block diagram of an embodiment of the Web service provider at design time.

FIG. 3 is a flow chart showing an example of operations performed by the Web service provider at design time.

FIG. 4 is a block diagram of an embodiment of the Web service provider at runtime.

FIG. 5 is a flow chart showing an example of operations performed by the Web service provider at runtime.

FIG. 6 is a graphical user interface (GUI) showing an overview screen of a creation wizard for creating a Web service.

FIG. 7 is a GUI showing a first screen of the creation wizard.

FIG. 8 is a GUI showing a second screen of the creation wizard.

FIG. 9 is a GUI showing a third screen of the creation wizard.

FIG. 10 is a GUI showing a fourth screen of the creation wizard.

FIG. 11 shows an example of a Web Services Description Language (WSDL) file.

FIG. 12 is a GUI showing an example of testing environment for the Web service.

### DETAILED DESCRIPTION

A method and system for a Web service tool is described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, to avoid obscuring embodiments of the present invention.

The Web service tool, as described herein, allows a Web service designer to quickly create new services tailored to the specific needs of an organization. With the Web service tool, program code implementing a customized Web service can be generated automatically without manual coding. Instead, a designer merely needs to select pre-defined business objects and their associated attributes to define the Web service. The Web service tool provides a user-friendly creation wizard, which guides a designer stage by stage in the definition process of the Web service. The creation wizard hides technical complexity of building a Web service and allows rapid service deployment. In some embodiments, Web services created by the Web service tool comply with the World Wide Web Consortium (W3C) standard. Therefore, Web services created by the tool can be used by all enterprise service-oriented architecture (SOA) enabled applications

In some embodiments, the Web service tool is able to utilize the application program interface (API) and functionalities provided by NetWeaver® to test a Web service at design time and operate the Web service at runtime. NetWeaver® is a business application that integrates business processes across various sources and is a product of SAP AG located in Germany.

With the Web service tool, an enterprise can build Web services that allow its customers to access product and price information from an external system, e.g., the customers' procurement systems. The Web services can also allow the customers to create sales orders in the enterprise's Customer Relationship Management (CRM) system. For example, the sales order can be created by linking the customer's procurement software to the enterprise's order management application.

The Web service tool allows a designer to create standard Web service operations, such as read, create, query, and change services for business objects in a CRM system. In some embodiments, security and user authorizations of the Web services can be handled by the standard NetWeaver® Web services environment.

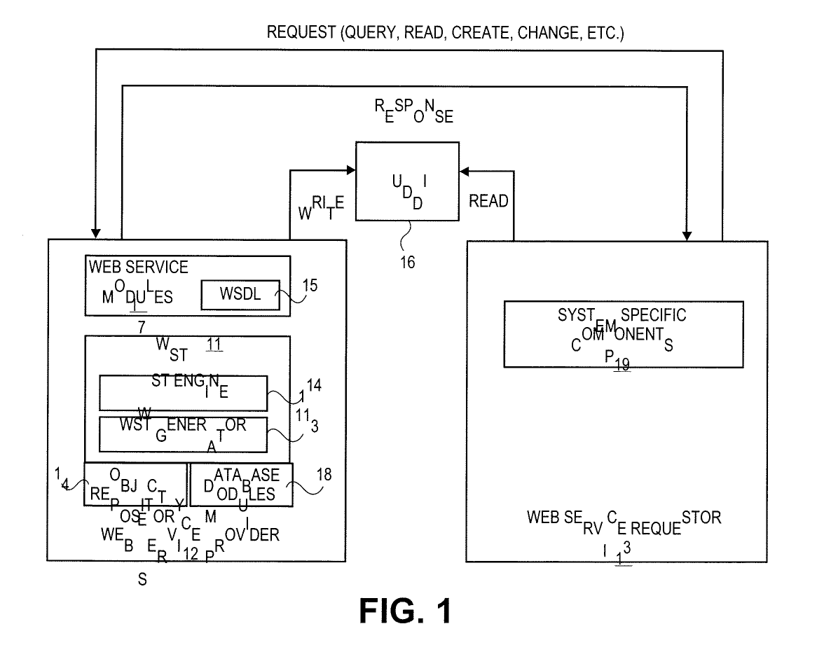

FIG. 1 shows an embodiment of an environment in which a Web service tool (WST) 11 may operate. WST 11 is located on a Web service provider 12 that provides Web services to one or more Web service requesters 13 (“requesters”). For simplicity of the description, detailed information of Web service provider 12 and requester 13 is omitted from FIG. 1. Web service provider 12 may be centrally located on a server or distributed among more than one networked host machines. Note that Web service provider 12 and requestor 13 may be implemented by processing logic which may include software, hardware, or a combination of both.

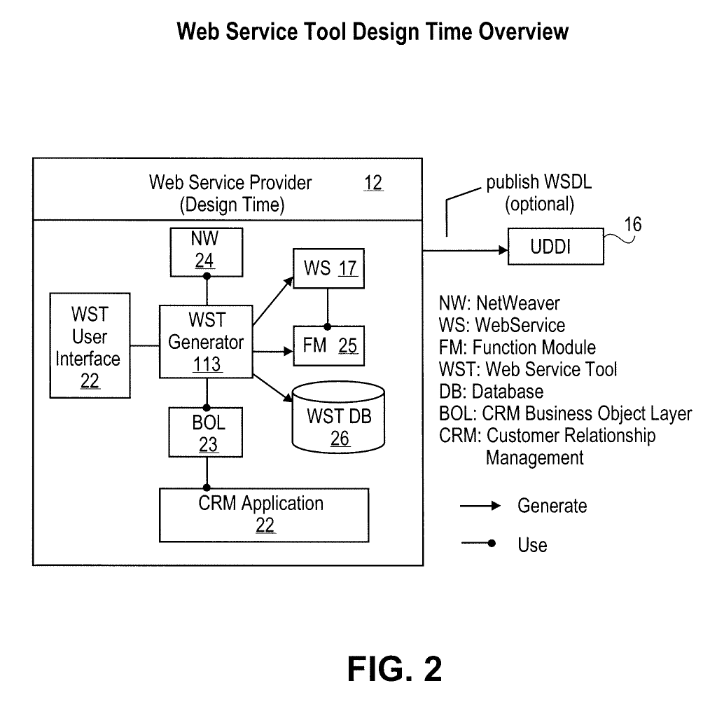

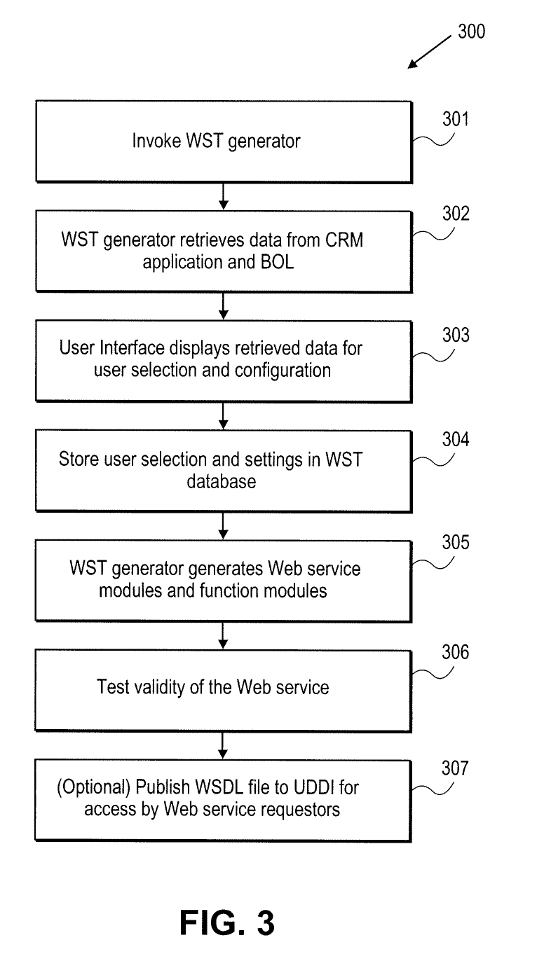

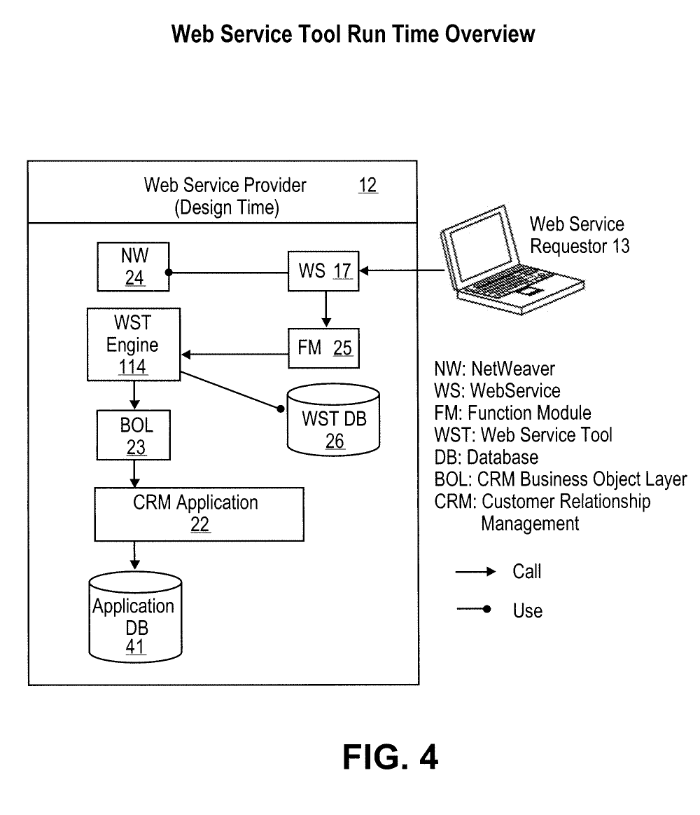

In the embodiment of FIG. 1, Web service provider 12 includes WST 11, Web service modules 17, an object repository 14, and database modules 18. Requestor 13 includes system specific components 19 for requesting Web services. Using WST 11, Web service provider 12 generates Web service modules 17 allowing requestors 13 to invoke the query, read, create, change operation of the Web service. Web service module 17 responds to the request by providing the Web services that are generated and operated by WST 11. Web service module 17 delivers a Web Service Description Language (WSDL) file 15 on demand to describe interface information for the Web service. WSDL file 15 may be generated on the fly, or generated offline and stored in memory. In some scenarios, WSDL file 15 is published or written onto a registry, e.g., Universal Description Discovery and Integration (UDDI) 16, for access by requesters 13 or other external systems. UDDI 16 is a platform-independent registry based on extensible markup language (XML). UDDI 16 is generally utilized by businesses worldwide to list themselves on the Internet. WST 11 includes a WST generator 113 for use during the design time of the Web service, and a WST engine 114 for use during runtime of the Web service. Details of WST generator 113 and WST engine 114 will be described below with reference to FIG. 2 and FIG. 3. Additionally, Web service provider 12 includes object repository 14 for providing pre-defined business objects, and database modules 18 for storing user selections. In the embodiments described below with reference to FIG. 2 and FIG. 4, object repository 14 is formed by a portion of Customer Relationship Management application and a CRM business object layer, and database modules 18 are formed by a Web service tool database and an application database. A skilled person in the art will appreciate that the specific components described herein are for illustration only; other configurations may exist.

FIG. 2 is a block diagram showing an embodiment of Web service provider 12 during design time of a Web service. FIG. 3 is a flowchart showing an example of design time operations 300 of Web service provider 12. Note that the process as shown in FIG. 3 may be performed by processing logic which may include software, hardware, or a combination of both.

Referring to FIG. 2 and FIG. 3, WST generator 113 is invoked at the request of a designer who wishes to generate a Web service (block 301). To generate a Web service, WST generator 113 first retrieves information from a Customer Relationship Management (CRM) application 22 and a CRM business object layer (BOL) 23 (block 302). In the context of FIG. 2, CRM application 22 includes various business applications, including, but not limited to, product, transactions and activities. These business applications can be accessed through BOL 23. BOL 23 offers two main types of objects: business objects and query services. Business objects herein refer to business entities or related business activities, which are the building block of a Web service. Examples of business objects include, but are not limited to, business partner, service order, service confirmation, lead, quotation, marketing campaigns, and call lists. Compared to a business application, a business object represents a process that has a more atomic character. A business application is generally composed of multiple business objects. It generally takes time to observe a business to determine whether a process is a business object or a business application. Query services can be used to search specific business objects within BOL 23 during runtime. A query service is defined by using a query object. A designer can define as many query services on top of a query object as he/she likes. Similarly, a designer can define “read” services, “create” services, and “change” services using respective objects for runtime operations.

After retrieving the information from CRM application 22 and BOL 23, WST generator 113 displays the retrieved data on a WST user interface 22 for user selection and configuration (block 303). The selection and settings are then stored in a WST database 26 for use during runtime of the Web service (block 304). According to the user selection and settings, WST generator 113 generates data and function modules, e.g., Web service modules 17 and function modules 214, which are utilized during runtime of the Web service (block 305).

As mentioned above with reference to FIG. 1, Web service modules 17 include WSDL file 15 to describe the interface and message formats of the Web service. Function modules 25 include logic for performing user-specified Web services at runtime. Function modules 25 also include data dictionary (DDIC) objects, which is a set of metadata that contains definitions and representations of data elements in the function modules. In some embodiments, function modules 25 are implemented in Advanced Business Application Programming (ABAP), which is a programming language designed for building business applications. However, a person skilled in the art would appreciate that other programming languages may also be used. In some embodiments, WST generator 113 utilizes the functionalities of NetWeaver® 24 to test the consistency of the Web service (block 306). The resulting Web service may be published to UDDI 16 by writing WSDL file 15 to a public location (e.g., the Internet) accessible to requesters 13 (block 307). In FIG. 2, WST engine 114, which is inactive during the design time, is not shown for simplicity of the descriptions.

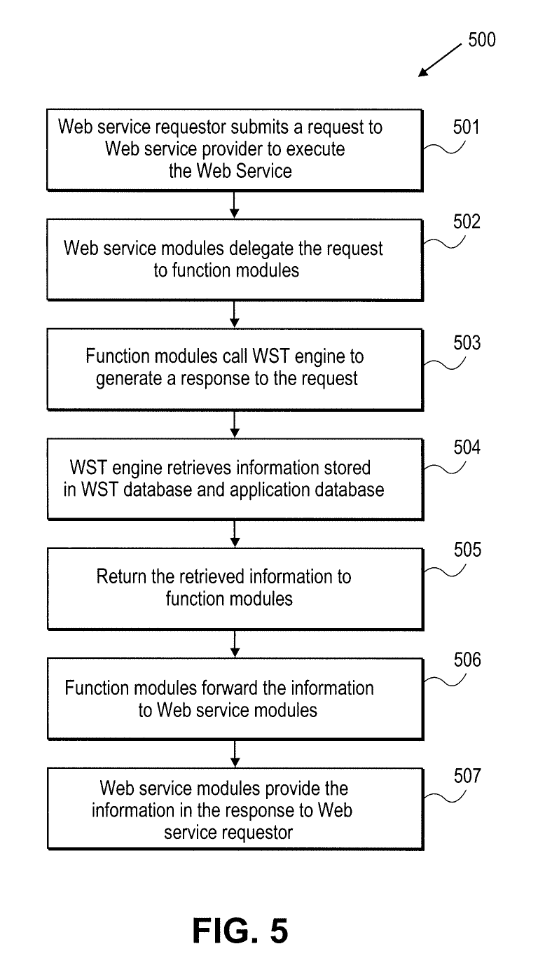

FIG. 4 is a block diagram showing an embodiment of service provider 12 during runtime of a Web service. FIG. 5 is a flowchart showing an example of runtime operations 500 of Web service provider 12. Note that the process as shown in FIG. 5 may be performed by processing logic which may include software, hardware, or a combination of both.

Referring to FIG. 4 and FIG. 5, initially, requestor 13 submits a request to Web service provider 12 to execute the Web service (block 501). In response to the request, Web service modules 17 delegate the request to function modules 25 (block 502). In some scenarios, Web service modules 17 utilize the functionalities provided by a business application, e.g., NetWeaver® 24, to delegate the request to function modules 25. However, it is within the scope of the embodiments of the invention that Web service modules 17 perform runtime operations independent of NetWeaver® 24. After receiving the request, function modules 25 call WST engine 114 to generate a response to requester 13 (block 503). WST engine 114 retrieves requested information from WST database 26 and an application database 41 (block 504). WST database 216, as mentioned above with reference to FIG. 2, stores the user selection and settings. Application database 41 stores business data or records that requester 13 wishes to retrieve, create or modify, as specified in the request. The business data or record in application database 31 includes, but is not limited to, account, sales order, and product information, e.g. account “Henry Smith” bought 100 blocks of Chocolate XYZ. Application database 41 can be accessed through CRM application 22 and BOL 23.

The information retrieved in block 504 is returned to function modules 25 (block 505), which in turn forwards the information to Web service modules 17 (block 506). Web service modules 17 provide the information in the response to requester 13 (block 507). In FIG. 4, WST generator 113, which is inactive during runtime, is not shown for simplicity of the discussion.

The following description provides more details to the generation of a Web service using the components described above. To create a Web service, WST user interface 22 of FIG. 2 provides a four-step creation wizard that leads a designer through the definition process of the Web service. The term “wizard” as used herein refers to a graphical user interface (GUI) that enables a designer to complete a task in pre-defined stages or steps. The creation wizard allows a designer to create a Web service by simply entering basic information relating to the Web service and selecting from pre-defined objects and their associated attributes. There is no manual coding involved in the creation of a Web service. The creation wizard guides a designer stage by stage, and provides a user-friendly interface to allow easy navigation to different stages.

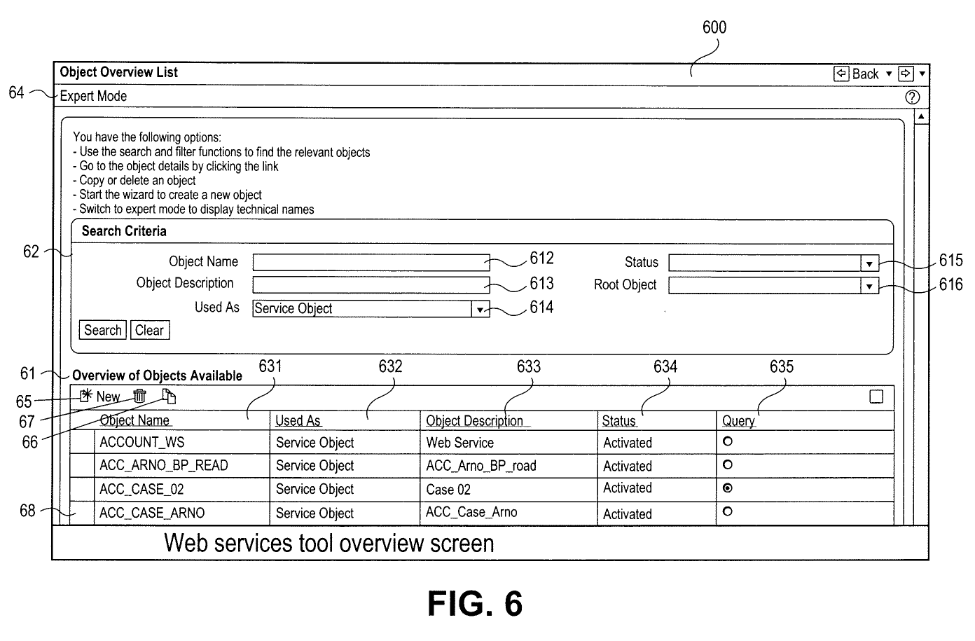

FIG. 6 shows an example of an overview screen 600 of WST user interface 22. Overview screen 600 includes an overview list 61 and a search panel 62. Search panel 62 in overview screen 600 allows a Web service designer to enter various search and filter criteria for locating an object in the existing objects. In the embodiment shown in FIG. 6, search panel 62 includes input boxes for an object name 612, an object description 613, an object type (“used as”) 614, an object status 615, and a corresponding root object 616. A designer may enter one or more search and filter criteria. For example, a designer may enter an object type “service object” and an “activated” status to see all the existing activated service objects in overview list 61.

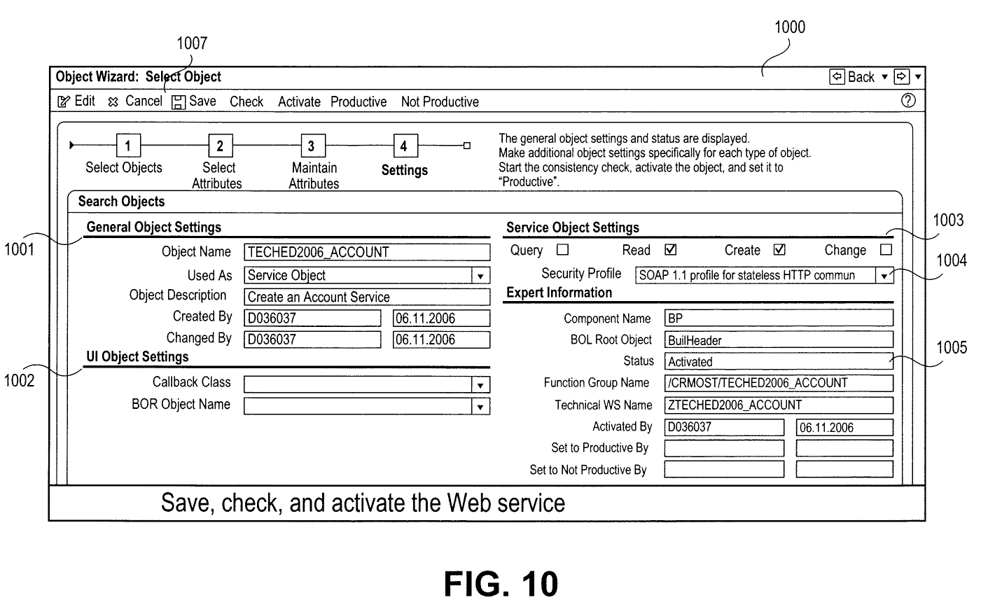

Overview list 61 includes a plurality of data fields, e.g., object name field 631, a “used as” (object type) field 632, an object description field 633, an object status field 634, and a query field 635. Object status field 634 indicates the current status of the object (e.g., draft, activated, productive, or non-productive), which will be described in detail below with reference to FIGS. 10-12. Query field 635 indicates whether an object can be queried. From overview list 61, a designer can jump into the details of an existing object, or start the creation wizard to create a new object. For example, the label “object name” in object name field 631 may be a clickable link that links to the detailed information of the objects. To see the technical details of an existing object and its attributes, a designer can select an object in overview list 61 and click on an expert mode icon 64 in the navigation bar. By switching to the expert mode, a designer can view the technical names used for BOL structures or an entity within a BOL structure.

Overview screen 600 also allows a designer to copy or delete an existing object. A copy icon 66 and a delete icon 67 are provided in the menu bar of overview list 61. A designer may select an object from overview list 61 (e.g., by clicking on the box 68 next to the selected object name), and click on copy icon 66 or delete icon 67 to copy or delete the selected object. The copy function allows a designer to create a new object by copying an existing object and then modifying or enhancing the copied object. The modification or enhancement can be made by adding or changing attributes associated with the object. The copy function guarantees reusability and extensibility of the Web services. Thus, a worldwide enterprise can define its best practice Web services by adopting a standard set of objects. This standard set of objects may be copied and enhanced by the enterprise's IT departments worldwide to adapt to country-specific needs. For example, Web service security settings of a copied object can be changed according to the planned usage environment of the service.

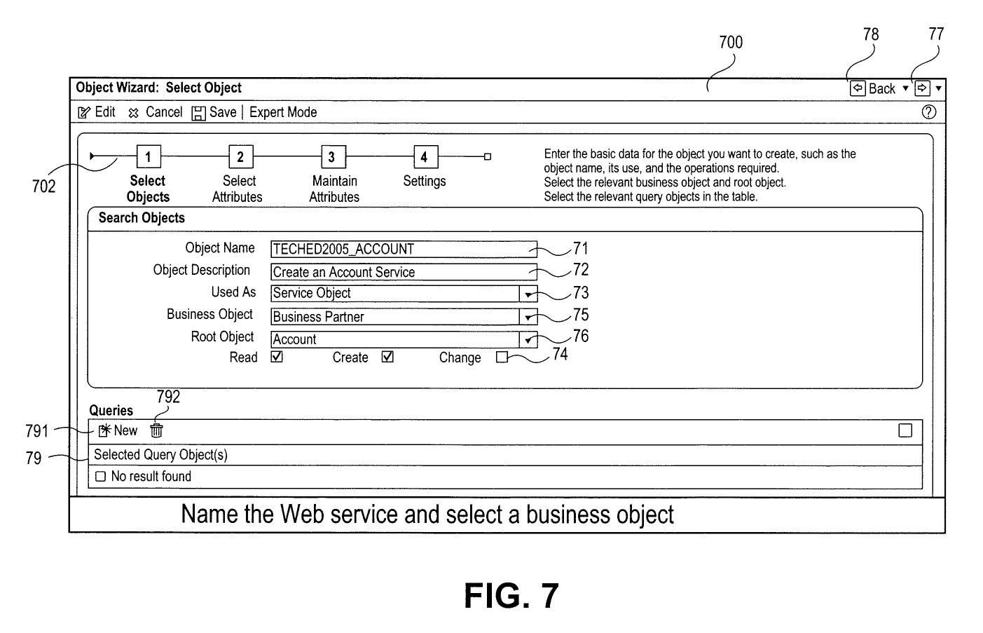

To create a new object, such as a service object that defines a Web service, a designer can click on a “New” button 65. When the designer clicks on New button 65, a first screen 700 of the creation wizard is displayed. FIG. 7 shows first screen 700 of the creation wizard that allows a designer to enter basic information for a new Web service defined by a service object to be created. In the embodiment of FIG. 7, the basic information includes an object name 71, an object description 72, “used as” (object type) 73, operations 74 (e.g., read, create, and change), a business object 75 (e.g., a BOL 23 component), and a root object 76. In this example, a new Web service is created with two operations to create and read a business partner account.

First screen 700 also includes a query section 79 that displays a list of available query objects. In the example shown in FIG. 7, no query object is currently available. A new query object can be created for the Web service by clicking on a New icon 791. An existing query object can be selected for deletion by clicking on a recycle icon 792.

To navigate to the next wizard screen, the designer can click on a right arrow 77, or directly select the (1-2-3-4) wizard icons 702 on top of first screen 700. At any stage of the creation wizard, a designer can move to a prior or a next screen by clicking on a left arrow 78 or right arrow 77, or may jump to any creation stage by clicking on a number on wizard icon 702 corresponding to the destination stage. It is understood that the location of the icons in any of the screens described herein may vary from the specific embodiments as shown without departing from the broad spirit of the invention. For example, left arrow 78 and right arrow 77, as well as the corresponding arrows in other screens described herein, may be located at the bottom of the corresponding screen.

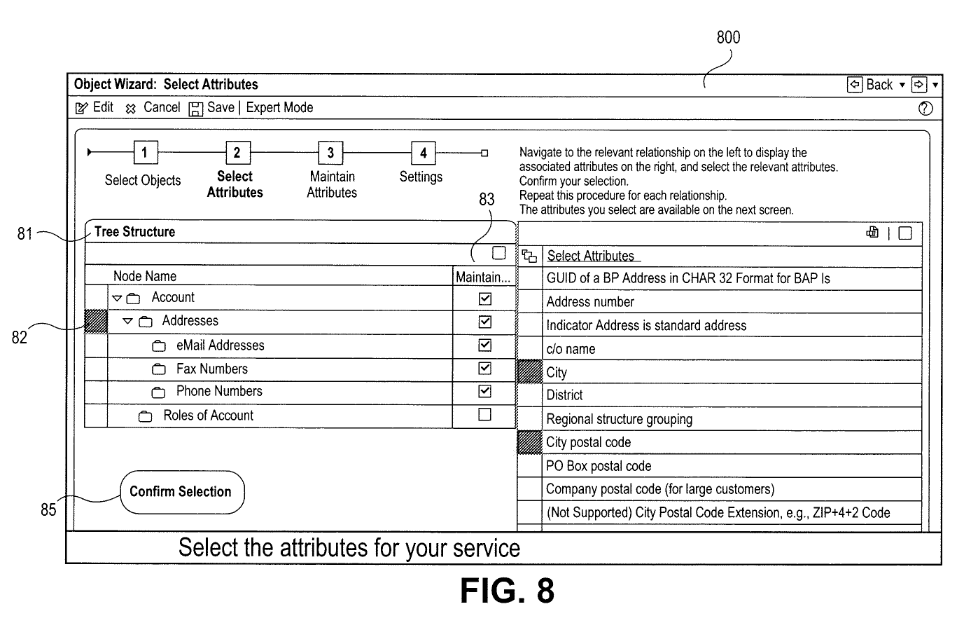

FIG. 8 shows an example of a second screen 800 of the creation wizard. Second screen 800 allows a designer to select the attributes for the new Web service. The left part of second screen 800 shows a BOL tree 81 that includes a plurality of nodes. A designer can select a node by clicking on a blue box 82 to the left of the node. The attributes associated with the selected node appear in the right part of second screen 800. After the necessary attributes are selected, the designer can confirm the selection by clicking on a confirm selection button 85 at the bottom of second screen 800. The process may be repeated until no more nodes and attributes are needed for the Web service. After all necessary nodes and attributes are selected, the designer can navigate to the next screen. As shown in the example, the attributes City and City postal code are selected from the node “addresses.” Each node of BLO tree 81 is associated with a maintain selector 83 that shows which nodes have been selected. Thus, after a designer goes to anther screen and later comes back to review or change the definition of the Web service, he/she may consult maintain selectors 83 to find out the nodes that are already selected for the Web service.

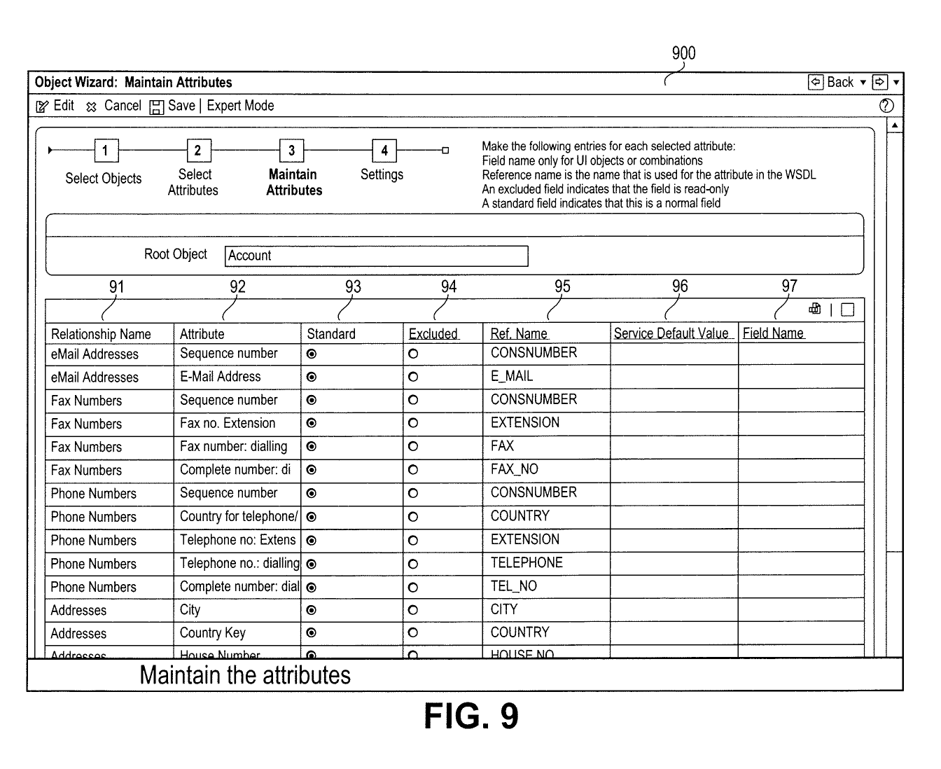

FIG. 9 shows an example of a third screen 900 in which certain properties of the attributes selected in second screen 800 can be set. In third screen 900, a designer can exclude attributes from WSDL file 15, rename the attributes, and specify default values for the Web services. As a result, the excluded attributes are excluded from the resulting Web service, and the renamed attributes are also reflected in WSDL file 15. Depending on the needs of Web service provider 12, a designer can prevent changes to the default values or allow requestor 13 to overwrite the attributes. This feature hides the internal service structure from Web service requestors 13 and increases the flexibility in customizing the Web service.

More specifically, default values can be used to limit a requestor's options. For example, if requestor 13 is to create leads in the Web service provider's CRM system, the Web service provider can set a default value that limits the leads in a certain category. Default values also can hide system-specific data from requestor 13. For example, a designer can set certain data fields as mandatory and use default values for these fields. These mandatory fields can then be excluded from the WSDL file of the Web service to reduce the complexity of the Web service interface.

Third screen 900 also allows a designer to change attribute names for the attributes selected in second screen 800. Attributes can be renamed to customary names or code names that have a specific meaning within an organization. The renaming feature allows Web service provider 12 to create Web services interfaces customized for a common company language, and therefore helps to reduce the complexity of the service interfaces. The renaming feature is also useful if the Web services are to be used in another country where idiomatic usage of language is different. For example, the “House Number” attribute can be renamed to “Street Address.”

Third screen 900 includes a list of the selected attributes and the related information, including a relationship (or node) name 91, attribute description 92, whether the attribute is standard 93 or excluded 94, a reference name 95, a default value 96, and a field name 97. Relationship name 91 is the internal name used by WST 11, a marked excluded 94 field indicates that the attribute is excluded from WSDL file 15, and a marked standard 93 field indicates that the attribute is not excluded. Reference name 95 is the new name given to the renamed attribute and is the name used for the attribute in the WSDL file describing the new Web service. Field name 97 is limited for user interface objects or combinations.

Although not shown in FIG. 9, a designer may also set attributes for query objects in third screen 900, if any query object is created in first screen 700. The creation wizard provides a predefined set of attributes for each query object. If a query object is selected in query section 79 of first screen 700, unnecessary attributes associated with the query object can be excluded or changed.

FIG. 10 shows an example of a fourth screen 1000 of the creation wizard. Fourth screen 1000 provides a summary of the new Web service that is just created. Fourth screen 1000 displays the general object settings 1001, user interface object settings 1002, service object settings 1003 (e.g., query, read, create, and change), security profile 1004, and expert information 1005 (e.g., BOL root object, technical service name, function group name, etc.).

In fourth screen 1000, a designer can save the new Web service, start the consistency check, activate the Web service, and set the Web service to a “productive” status. The designer can save the new Web service by clicking a save icon 1007 on the menu bar. A corresponding save icon is also provided in each of the screens 700, 800, and 900 for saving the design in progress.

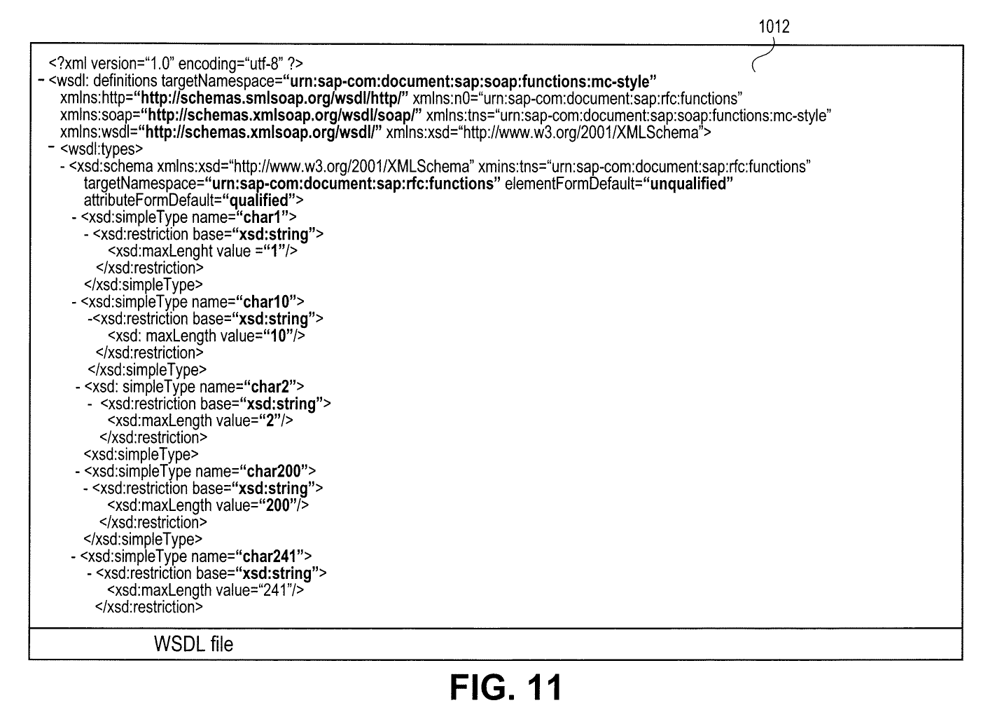

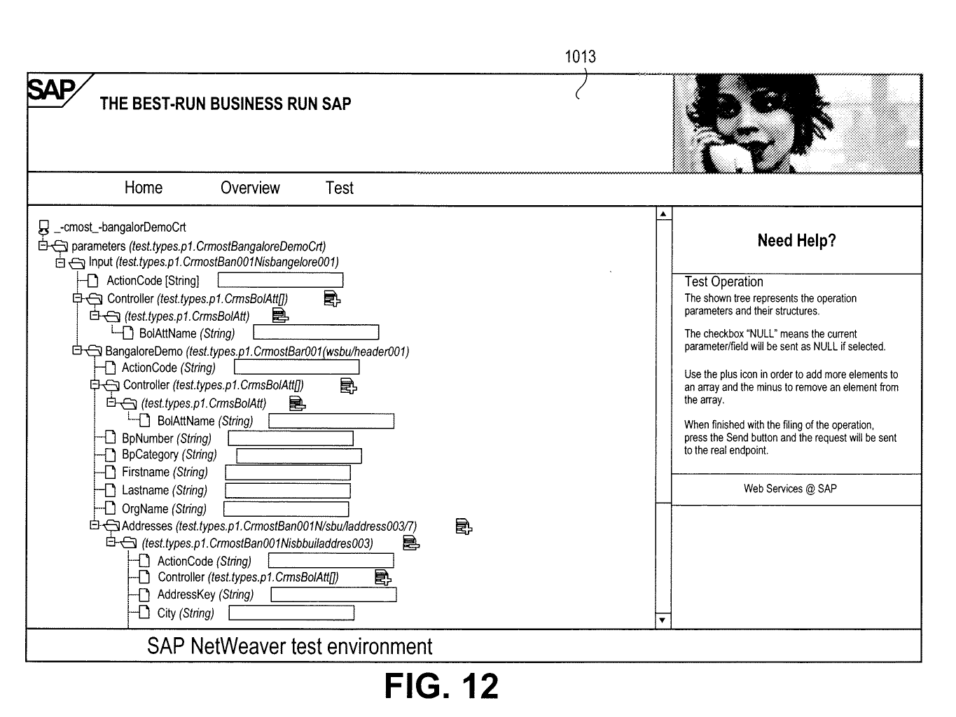

After the Web service is saved and activated, a designer can directly open and export the associated WSDL file 1012 (FIG. 11), or start a testing environment, e.g., NetWeaver® (FIG. 12), to check the consistency of the file. WSDL file 1012 describes the interface of Web service and is necessary for Web service requester 13 to call or consume the Web service from another application.

During the activation process of the Web service, WST generator 113 generates Web service module 17 and function modules 25 (FIG. 2) in the background. After the activation, the new Web service is ready for use from an application that runs on an external system, such as Web service requester 13 of FIG. 1. Examples of the application include, but are not limited to, Microsoft® Excel, Adobe® Forms, or any application software facilitating the use of the Web service. At this point, the Web service can be released for external calls.

A service object, such as the Web service just created, can have one of the four different states: draft, activated, productive, or non-productive. A designer can edit, delete, or change the attributes associated with the object depending on the status. The initial status is draft. In this status, the Web service under creation can be changed, deleted, or copied. After the Web service is created and activated, its status switches from draft to activated and the service becomes available. Deletion and copy of an activated Web service is also possible. Whenever the service definition is to be changed, e.g., by adding more attributes, the status of the service can be set back to draft. After the Web service has been successfully tested, its status can be set to productive to prevent anyone from changing or deleting the service. However, a productive Web service can be copied and the copied version can be modified. If the status of a Web service is non-productive, the Web service can be deleted but not changed.

A method and system for generating a Web service has been described herein. Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative, to a machine, or in combination with a machine) electronic circuitry designed to perform the processes (or a portion thereof) without the execution of program code.

It is believed that processes taught by the discussion above may also be described in source level program code in various object-orientated or non-object-orientated computer programming languages supported by various software development frameworks. The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link such as a network connection).

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
receiving an input that selects an object and an associated attribute from a repository of pre-defined business objects via a graphical user interface; and
automatically generating code that describes and implements a Web service according to the selected object and the associated attribute.

2. The method of claim 1 further comprising:
guiding a user, through the graphical user interface, to create the Web service in pre-defined stages.

3. The method of claim 1 wherein automatically generating code comprises:
automatically generating a Web Services Description Language (WSDL) file to describe an interface of the Web service.

4. The method of claim 1 wherein automatically generating code further comprises:
automatically generating function modules that include logic for performing runtime operations of the Web service.

5. The method of claim 1 wherein receiving an input comprises:
setting a default value for the associated attribute according to the input; and
specifying whether the default value can be overwritten by a requestor of the Web service.

6. The method of claim 1 wherein receiving an input further comprises:
changing a name of the associated attribute according to the input.

7. The method of claim 1 further comprising:
copying functionalities of the selected object; and
changing the associated attribute based on planned usage of the Web service.

8. The method of claim 1 further comprising:
testing and running the Web service using a business application that integrates business processes across various sources.

9. A system comprising:
a graphical user interface to receive an input that selects a business object and an associated attribute;
a Web service generator coupled to the graphical user interface to automatically generate code that describes and implements a Web service according to the selected object and the associated attributes; and
a Web service engine to perform runtime operations of the Web service.

10. The system of claim 9 further comprising:
a business application used by the Web service generator to test the Web service and by the Web service engine to run the Web service.

11. The system of claim 9 wherein the graphical user interface comprises:
a creation wizard to guide a user in creation of the Web service in pre-defined stages.

12. The system of claim 9 wherein the code comprises:
a Web Services Description Language (WSDL) file to describe an interface of the Web service; and
function modules to perform runtime operations of the Web service.

13. The system of claim 9 further comprising:
a business object layer (BOL) to provide pre-defined business objects and query services for user selection.

14. The system of claim 9 further comprising:
a web service tool database to store user selection for generation and the runtime operations of the Web service.

15. A machine-readable medium having instructions, which when executed, cause a machine to perform a method, the method comprising:
presenting a graphical user interface to create a Web service in pre-defined stages;
receiving a user input from the graphical user interface; and
automatically generating code that defines and implements the Web service according to the selected object and the associated attribute.

16. The machine-readable medium of claim 15, wherein receiving a user input comprises:
receiving selection of an object and associated attributes from an object repository that store pre-defined business objects.

17. The machine-readable medium of claim 15, wherein receiving a user input comprises:
receiving the user input that specifies an operation available to a requester of the Web service with respect to the selected object.

18. The machine-readable medium of claim 15, wherein automatically generating code further comprises:
automatically generating a Web Services Description Language (WSDL) file to describe an interface of the Web service; and
automatically generating function modules that include logic for performing runtime operations of the Web service.

19. The machine-readable medium of claim 15, wherein presenting a graphical user interface comprises:
providing icons in a display showing the pre-defined stages; and
in response to selection of one of the icons, displaying a screen corresponding to one of the pre-defined stages.

20. The machine-readable medium of claim 15, wherein presenting a graphical user interface further comprises:
providing an expert mode selector in the graphical user interface; and
displaying detailed information of the selected object in response to activation of the expert mode.
